(19) United States
(12) Patent Application Publication
(10) Pub. No.: US 2011/0175554 A1
(43) Pub. Date: Jul. 21, 2011

(54) PLASMA DISPLAY PANEL

(76) Inventors: Osamu Inoue, Osaka (JP); Hiroshi Asano, Osaka (JP); Yayoi Okui, Osaka (JP); Kojiro Okuyama, Nara (JP)

(21) Appl. No.: 12/990,197

(22) PCT Filed: Mar. 29, 2010
(86) PCT No.: PCT/JP2010/002238

§ 371 Date: Oct. 28, 2010

(30) Foreign Application Priority Data
Jun. 10, 2009 (JP) 2009-139097

(51) Int. Cl. H05B 41/00; H01J 1/62

(52) U.S. Cl. 315/334; 313/484

(57) ABSTRACT

The present invention aims to provide a plasma display panel that can be driven at low voltage and can offer favorable image display performance. In order to achieve the aim, on a surface of the front panel 1 on which the display electrode 5 is formed, the protective layer 7 made by using a crystalline oxide material that contains a crystalline oxide selected from the group consisting of (i) at least one of SrCeO₃ and BaCeO₃ and (ii) a solid solution of SrCeO₃ and BaCeO₃ is disposed so as to face the discharge space 14. By using the crystalline oxide material that contains the crystalline oxide selected from the group consisting of (i) at least one of SrCeO₃ and BaCeO₃ and (ii) a solid solution of SrCeO₃ and BaCeO₃, chemical stability can be improved without reducing secondary electron emission efficiency. A PDP capable of lowering drive voltage compared with a case where MgO is used can be obtained by using the crystalline oxide material.

### TECHNICAL FIELD

The present invention relates to a plasma display panel (PDP), and in particular to technology for improving a material for a protective layer or a material used in the vicinity of the protective layer.

### BACKGROUND ART

Plasma display panels (hereinafter, abbreviated as PDPs) have been in practical use and have rapidly become popular because they can easily be made in large sizes, are capable of high speed display, and are low cost.

A general PDP that is presently in practical use has a structure in which two glass substrates being front and back substrates are disposed so as to oppose each other, a plurality of electrodes (display electrode pairs or address electrodes) are arranged in a regular manner on each of the front and back substrates, and a dielectric layer made, for example, of a low melting glass is formed so as to cover each of the electrodes on the front and back substrates. A phosphor layer is provided on the dielectric layer formed on the back substrate. On the dielectric layer formed on the front substrate, an MgO layer is provided as a protective layer for protecting the dielectric layer from ion bombardment during discharge and improving secondary electron emission. The two substrates are then sealed together so as to enclose a discharge space. The discharge space is filled with a gas mainly composed of an inert gas such as Ne and Xe. When the PDP is driven, discharge is caused by applying voltage between electrodes. Images are displayed on the PDP by causing phosphors to emit light by the discharge.

There is a strong demand for improving efficiency of a PDP. As a method for improving the efficiency, a method of lowering dielectric constant of the dielectric layer and a method of increasing partial pressure of Xe in a discharge gas are known. Use of such methods, however, gives rise to the problem that firing voltage and sustaining voltage are increased.

On the other hand, it is known that the firing voltage and the sustaining voltage can be lowered by using a material with a high secondary electron emission coefficient for the protective layer. Efficiency can be improved by using the material with the high secondary electron emission coefficient, and costs can be lowered by using an element with low pressure resistance. For these reasons, CaO, SrO, and BaO that are alkaline earth metal oxides as with MgO but have higher secondary electron emission coefficients than MgO, and a solid solution of these compounds are considered to be used instead of MgO (see Patent Literatures 1 and 2).

### CITATION LIST

### Patent Literature

### [Patent Literature 1]

Japanese Patent Application Publication No. S52-63663

### [Patent Literature 2]

Japanese Patent Application Publication No. 2007-95436

### SUMMARY OF INVENTION

### Technical Problems

CaO, SrO, BaO, and the like, however, are less chemically stable than MgO, and thus relatively readily react with moisture and carbon dioxide in the air or inside a panel to produce hydroxide and carbonate, respectively. When such compounds are produced, voltage cannot be lowered as intended due to reduction of a secondary electron emission coefficient of the protective layer.

When a small number of small-sized PDPs are produced on a laboratory scale, such degradation due to chemical reaction is avoidable by, for example, controlling atmospheric gases during operation. In a manufacturing plant, however, it is difficult to actually control atmosphere during the whole process. If such control were possible, it would cost too much. In particular, when large-sized PDPs are manufactured, the problem becomes evident. For the above-mentioned reason, although the use of a material with a high secondary electron emission coefficient has been considered, only MgO is in practical use. Therefore, lowering of voltage and improvement in efficiency cannot be fully achieved.

In addition, when a material other than MgO is used for the protective layer, the protective layer is more likely to be sputtered by discharge gases during driving of a PDP because the protective layer shows low resistance to ion bombardment. This leads to a problem that the life of the PDP is reduced.

The present invention has been achieved in view of the above problems, and aims to provide a PDP that can offer favorable image display performance and can be driven at low voltage by using a compound with high secondary electron emission properties.

### Solution to Problems

In order to solve the above problems, one aspect of the present invention is a plasma display panel that has a plurality of electrodes and phosphors, causes discharge in a discharge space by applying voltage between one or more pairs of electrodes among the plurality of electrodes, and causes the phosphors to emit visible light by the discharge, wherein a crystalline oxide material that contains a crystalline oxide selected from the group consisting of (i) at least one of SrCeO₃ and BaCeO₃ and (ii) a solid solution of SrCeO₃ and BaCeO₃ is disposed so as to face the discharge space.

Here, the crystalline oxide material may further contain another crystalline oxide that is obtained by partially substituting one or more Ce atoms in the above-mentioned crystalline oxide with one or more trivalent or tetravalent metal atoms.

It is preferable that the trivalent metal atoms be In atoms or rare earth metal atoms.

It is desirable that the tetravalent metal atoms be Sn atoms.

Another aspect of the present invention is a plasma display panel having first (front) and second (back) panels, the first panel including a first substrate (front glass substrate), a plurality of first electrodes (display electrodes) disposed on the first substrate, a first dielectric layer disposed so as to cover the first electrodes, and a protective layer disposed on the first dielectric layer, the second panel including a second substrate (back glass substrate), a plurality of second electrodes (address electrodes) disposed on the second substrate, a second dielectric layer disposed so as to cover the second electrodes, and a phosphor layer disposed on the second dielectric layer, wherein the crystalline oxide material of the present invention is used for the protective layer, and the first and second panels oppose each other with a discharge space therebetween.

Here, a material composed of MgO may be dispersed on the protective layer in particulate form.

The other aspect of the present invention is a plasma display panel having first and second panels, the first panel including a first substrate, a plurality of first electrodes disposed on the first substrate, a first dielectric layer disposed so as to cover the first electrodes, and a protective layer disposed on the first dielectric layer, the second panel including a second substrate, a plurality of second electrodes disposed on the second substrate, a second dielectric layer disposed so as to cover the second electrodes, and a phosphor layer disposed on the second dielectric layer, wherein the crystalline oxide material of claim 1 is dispersed on the protective layer in particulate form, and the first and second panels oppose each other with a discharge space therebetween.

Here, it is preferable that a ratio at which the dispersed crystalline oxide material covers the protective layer be in a range of 1% to 20% inclusive.

A material composed of MgO may be dispersed on the protective layer in particulate form along with the crystalline oxide material.

Alternatively, a material composed of MgO may be dispersed on the crystalline oxide material in particulate form.

As shown above, the present invention is a plasma display panel characterized in that a crystalline oxide material that contains a crystalline oxide selected from the group consisting of (i) at least one of SrCeO₃ and BaCeO₃ and (ii) a solid solution of SrCeO₃ and BaCeO₃ is disposed as an electron emissive material so as to face the discharge space.

It is desirable that the crystalline oxide material further contain another crystalline oxide that is obtained by partially substituting one or more Ce atoms in the above-mentioned crystalline oxide with one or more trivalent or tetravalent metal atoms. Furthermore, it is desirable that the above-mentioned crystalline oxide material be dispersed on the protective layer made of MgO in particulate form.

### ADVANTAGEOUS EFFECTS OF INVENTION

According to the present invention, a plasma display panel that can offer favorable image display performance and can be driven at low voltage can be provided by using a specific compound that is more chemically stable and has a higher secondary electron emission coefficient than MgO.

Alternatively, a plasma display panel that can be driven at low voltage, can offer favorable image display performance, and has a long life can be provided by using an MgO-based material that shows high resistance to ion bombardment for the protective layer as before and using the compound as an electron emissive material along with the material.

### BRIEF DESCRIPTION OF DRAWINGS

FIG. 1 is an exploded perspective view of a PDP in Embodiment 1 of the present invention.

FIG. 2 is a longitudinal sectional view of the PDP shown in FIG. 1.

FIG. 3 is an exploded perspective view of another PDP in Embodiment 2 of the present invention.

FIG. 4 is a longitudinal sectional view of the PDP shown in FIG. 3.

FIG. 5 shows examples of valence band spectra measured using XPS.

FIG. 6 shows examples of C1s spectra measured using the XPS.

### DESCRIPTION OF EMBODIMENTS

<Compound (Crystalline Oxide) of the Present Invention>

The inventors synthesized a great variety of compounds by reacting CaO, SrO, BaO that have high secondary electron emission efficiency but are chemically unstable with a variety of oxides of metals such as B, Al, Si, P, Ga, Ge, Ti, Zr, Ce, V, Nb, Ta, Mo, and W. The inventors then examined chemical stability and ability to emit secondary electrons of the synthesized compounds in detail. After the examination, the inventors could improve chemical stability without significantly reducing secondary electron emission efficiency by reacting CeO₂ to produce crystalline oxides including SrCeO₃, BaCeO₃, and a solid solution of them. They found that a PDP capable of lowering drive voltage compared with a case where MgO is used can be obtained by using the compounds.

SrCeO₃ and BaCeO₃ are both metal oxides having perovskite structures and are capable of forming a complete solid solution at any composition ratio. The solid solution of them exhibits properties intermediate between SrCeO₃ and BaCeO₃ in accordance with the composition ratio. The secondary electron emission efficiency of BaCeO₃ is higher than that of SrCeO₃, whereas SrCeO₃ is more chemically stable than BaCeO₃. Required chemical stability varies depending on process conditions in actual manufacturing. Therefore, a compound selected from the group consisting of SrCeO₃, BaCeO₃, and a solid solution of them of a proper ratio may be used in accordance with manufacturing environment.

Here, in SrCeO₃, BaCeO₃, or a solid solution of them, sites for an alkaline earth may be partially substituted with Ca or La, sites for Ce may be partially substituted with trivalent rare earth metals such as In and Y, Sn, Zr, and the like, and O may be partially substituted with F, as long as a perovskite structure is maintained. At this time, when Ce being a tetravalent metal is substituted with Sn also being a tetravalent metal, secondary electron emission efficiency is slightly reduced but chemical stability can be improved. Similarly, when Ce is substituted with In or Y being trivalent rare earth metals, chemical stability can be improved while secondary electron emission efficiency is further improved. Therefore, by such substitution, it becomes possible to finely adjust properties of the compounds. Two or more elements may be substituted in one substitution. When substitution is performed in such a manner, however, main components in composition have to be an alkaline earth, Ce, and O.

Furthermore, when SrCeO₃, BaCeO₃, and a solid solution of them are used in a normal manufacturing process in which atmosphere is not controlled, it is desirable that a ratio of the total number of moles of Sr and Ba to the number of moles of Ce, namely (Sr+Ba)/Ce be set to be 0.995 or less. This is because of the following reason. Even when the ratio is 1.000, an extremely small amount of SrO and BaO can remain after a reaction process of an alkaline earth oxide material with CeO₂ due to compositional heterogeneity. Under conditions in which atmosphere is not controlled, these compounds change to SrCO₃ and BaCO₃, and SrCO₃ and BaCO₃ cover surfaces of a compound, resulting in a reduction in a secondary electron emission coefficient.

Note that when sites for an alkaline earth or Ce are partially substituted as described above, it is preferable that the ratio be set to be 0.995 or less with respect to the total number of moles of substituted elements. When the ratio is further lowered, surplus CeO₂ is separated out at a certain ratio or lower, and thus a mixture of the compound and CeO₂ is formed. It is allowable because the above-mentioned formation of a compound including a large amount of alkaline earths can be suppressed in such a state.

As a method for synthesizing one or more crystalline oxides selected from the group consisting of SrCeO₃, BaCeO₃, and a solid solution of them, there are a solid phase method, a liquid phase method, and a gas phase method.

In the solid phase method, base powders including each metal (e.g. a metal oxide, and metal carbonate) are mixed, and reacted by heat treatment at a certain temperature or higher.

In the liquid phase method, a solid phase is precipitated in a solution including each metal, or the solution is applied to a substrate, dried, heat-treated at a certain temperature or higher and the like to form a solid phase.

The gas phase method is, for example, deposition, sputtering, and CVD. A membranous solid phase can be obtained in this method.

Any of these methods can be used in the present invention. When the compound is used in powder form, the solid phase method is normally preferred because manufacturing costs are relatively low and mass production is possible.

A crystalline oxide material that contains the compound may be disposed at any position in a PDP as long as it faces a discharge space. Generally, it is preferred that the crystalline oxide material be disposed on a dielectric layer that covers electrodes formed on a front plate. The crystalline oxide material, however, may be disposed on another part such as a phosphor part and a surface of a rib, or may be mixed into phosphors. In a PDP in which the crystalline oxide material was disposed so as to face the discharge space as described above, an effect of reducing drive voltage was confirmed by experiment compared with a PDP in which the crystalline oxide material was not used.

When the crystalline oxide material is disposed on the phosphor layer, it is desirable that an amount of the disposed crystalline oxide material be appropriately controlled so as not to lose luminescence property of the phosphors.

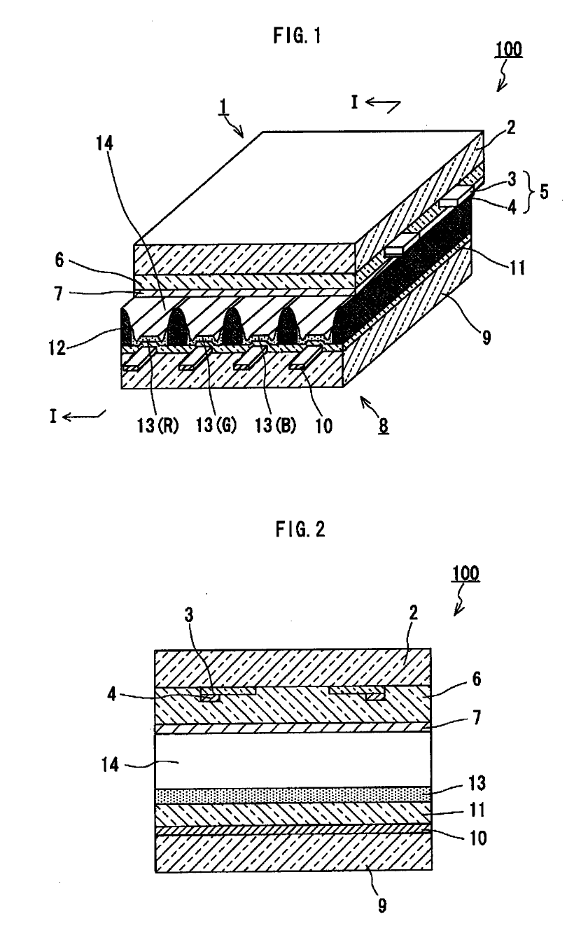

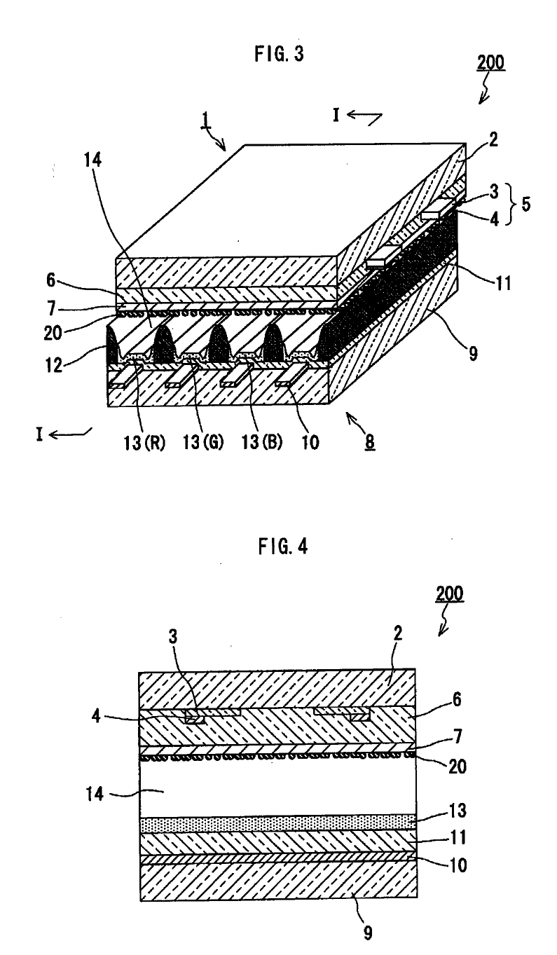

Next, as for a form of disposing the crystalline oxide material, when the crystalline oxide material is disposed on the dielectric layer that covers the electrodes formed on the front plate, for example, a film made of the crystalline oxide material may be disposed, or a powder of the crystalline oxide material may be dispersed, on the dielectric layer instead of an MgO film that is usually disposed as a protective layer as shown in FIGS. 1 and 2. Alternatively, as shown in FIGS. 3 and 4, after the MgO film is formed, the film made of the crystalline oxide material may be disposed, or the powder of the crystalline oxide material may be dispersed, on the MgO film.

The crystalline oxide material has a high melting point and is stable, but shows lower resistance to sputtering and has lower transparency than MgO. Therefore, when a powder of the crystalline oxide material is dispersed on the dielectric layer instead of a protective layer, degradation of brightness can become a problem. For these reasons, it is desirable that the MgO film be used as a protective layer as before, and the powder of the crystalline oxide material be dispersed on the MgO film at a level not causing the transparency problem.

It is preferable that a covering ratio of the powder of the crystalline oxide material be 20% or less in order not to cause the transparency problem. When an amount of the dispersed powder of the crystalline oxide material is too small, however, an effect of the powder is diminished. Therefore, it is preferable that the covering ratio fall within a range of 1% to 20% inclusive. When the crystalline oxide material is used as a powder, particle sizes thereof may be selected for, for example, cell sizes from within a range of about 0.1 μm to 10 μm. When the powder is dispersed on the MgO film, however, it is preferable that the particle sizes thereof be 3 μm or less, or desirably 1 μm or less in order not to cause movement or a fall of the powder on the MgO film. Note that, when a particle size of the crystalline oxide material is too large and therefore the crystalline oxide material is high in mass, the crystalline oxide material can fall in a discharge space.

With such a structure, an MgO film having a high melting point serves as a protective layer as before, while the crystalline oxide material of the present invention plays a role in secondary electron emission. In addition, since the covering ratio of the powder of the crystalline oxide material is low, reduction in brightness is prevented. Consequently, a PDP that can be driven at low voltage and has a long life can be obtained.

Recently, in order to solve a problem of discharge delay due to an increase in definition of a PDP, a crystalline MgO powder having high initial electron emission efficiency has been dispersed on the MgO protective layer. As a method for dispersing the crystalline MgO powder, the following method is adopted. The MgO powder is mixed with organic ingredients to form a paste. The paste is then printed on the MgO protective layer. After the printing, the MgO protective layer is heat-treated at a certain temperature to remove the organic ingredients. A powder of the crystalline oxide material of the present invention can be dispersed in the same method.

A powder of the crystalline oxide material and the MgO powder may be dispersed together on a surface of the protective layer. In this case, a paste including (i) the powder of the crystalline oxide material of the present invention and (ii) the crystalline MgO powder is prepared. After the paste is printed on the MgO protective layer, the MgO protective layer is heat-treated at a certain temperature to remove organic ingredients. This method is efficient because the powder of the crystalline oxide material and the crystalline MgO powder can be dispersed on the MgO protective layer in one process.

Note that, after one of the above-mentioned powders is dispersed on the protective layer, the other powder may be dispersed so as to laminate the dispersed powder. In this case, a paste including each powder is separately prepared, printed, and heat-treated.

Here, basically, the powder of the crystalline oxide material of the present invention may be dispersed on the protective layer first, or the crystalline MgO powder may be dispersed on the protective layer first.

When the MgO powder is covered with the powder of the crystalline oxide material of the present invention, however, an effect obtained by dispersing the MgO powder is less likely to be exerted. In this case, it is desirable that the powder of the crystalline oxide material of the present invention be dispersed first, and then the MgO powder be dispersed. With this structure, the powder of the crystalline oxide material of the present invention may be covered with the MgO powder. It is allowable, however, because an effect obtained by dispersing the powder of the crystalline oxide material is less likely to be eliminated by the MgO powder.

As described above, three functions having been performed by the MgO film, namely protection, reduction in voltage, and resolution of the problem of discharge delay, are fulfilled by the MgO film, the crystalline oxide material of the present invention, the crystalline MgO powder, respectively. Therefore, each of the three functions can be fulfilled by an optimal material, and thus a PDP with favorable properties can be provided.

Note that, in the Specification, a compound is described, for example, as “BaCeO₃”. Ce, however, is an element that tends to partly be Ce³⁺ in addition to Ce⁴⁺. An oxygen defect occurs in this case. Therefore, more accurately, the compound should be described as “BaCeO_{3-δ}”. δ here, however, changes depending on manufacturing conditions and the like and is not necessarily a constant value. For this reason, although the compound is described as “BaCeO₃” for the sake of convenience, such notation does not deny an existence of the oxygen defect. The same applies to compounds other than BaCeO₃ even when the oxygen defect exists in crystals.

### Embodiment 1

The following describes a specific example of a PDP of the present invention with use of drawings.

An example of a PDP of the present invention (Embodiment 1) is shown in FIGS. 1 and 2. FIG. 1 is an exploded perspective view of the PDP 100. FIG. 2 is a longitudinal sectional view (a sectional view taken along a line I-I of FIG. 1) of the PDP 100.

As shown in FIGS. 1 and 2, the PDP 100 includes a front panel 1 and a back panel 8. A discharge space 14 is formed between the front panel 1 and the back panel 8. The PDP 100 is a surface discharge AC-PDP, and has a structure similar to a structure of a conventional PDP except that a protective layer 7 is made by using the above-mentioned crystalline oxide material (the crystalline oxide material that contains a crystalline oxide selected from the group consisting of (i) at least one of SrCeO₃ and BaCeO₃, and (ii) a solid solution of SrCeO₃ and BaCeO₃) as an electron emissive material.

The front panel 1 includes a front glass substrate 2; a plurality of display electrodes 5 provided on an inner surface (on a surface facing the discharge space 14) of the front glass substrate 2; a dielectric layer 6 provided so as to cover the display electrodes 5; and a protective layer 7 provided on the dielectric layer 6.

Each of the display electrodes 5 is formed such that a bus electrode 4 made of Ag and the like for ensuring high conductivity is laminated to a transparent conductive film 3 made of ITO or tin oxide. Each of the display electrodes 5 is paired up with adjacent one of the display electrodes 5, and sustain discharge is caused between the pairs of the display electrodes 5 (each composed of a scan electrode and a sustain electrode).

Here, the protective layer 7 is made by using the above-mentioned crystalline oxide material (the crystalline oxide material of the present invention). Note that the protective layer 7 may be made only by using the above-mentioned crystalline oxide material, or may be made by using a mixture of the above-mentioned crystalline oxide material and MgO.

The back panel 8 includes a back glass substrate 9; a plurality of address (data) electrodes 10 provided on one surface of the back glass substrate 9; a dielectric layer 11 provided so as to cover the address electrodes 10; barrier ribs 12 provided on an upper surface of the dielectric layer 11; and a phosphor layer of each color provided between the barrier ribs 12. Regarding the phosphor layer of each color, a red phosphor layer 13 (R), a green phosphor layer 13 (G), and a blue phosphor layer 13 (B) are arranged in that order.

As phosphors that constitute the phosphor layer, for example, BaMgAl₁₀O₁₇:Eu can be used as blue phosphors, Zn₂SiO₄:Mn can be used as green phosphors and Y₂O₃:Eu can be used as red phosphors.

The front panel 1 and the back panel 8 are joined using a sealing member (not illustrated) such that longitudinal directions of the display electrodes 5 are orthogonal to longitudinal directions of the address electrodes 10, and the display electrodes 5 and the address electrodes 10 face each other. Discharge cells are formed in areas where pairs of the display electrodes 5 intersect with the address electrodes 10.

A discharge gas that is composed of a rare gas component such as He, Xe and Ne is enclosed in the discharge space 14.

Each of the scan electrodes and sustain electrodes that constitute the display electrodes 5, and the address electrodes 10 is connected to an external drive circuit (not illustrated). When a PDP is driven, voltage is applied to each of the display electrodes 5 and the address electrodes 10 by the corresponding drive circuit at a predetermined timing to perform addressing between predetermined scan electrodes and the corresponding address electrodes 10 in the discharge space 14, and thereby causing sustain discharge between pairs of the display electrodes 5. The phosphor layer 13 is excited to emit visible light by short wavelength ultraviolet light (147 nm wavelength) that is generated along with the sustain discharge. The emitted visible light passes through the front panel 1 to be provided for image display.

In the PDP 100 having the above-mentioned structure, the protective layer 7 made by using the above-mentioned crystalline oxide material is more chemically stable and exhibits more favorable secondary electron emission properties than a conventional one. Therefore, it is possible to cause sustain discharge in the discharge space 14 for a long time and offer favorable image display performance while driving the PDP at low voltage.

In addition, the PDP 100 can be realized at relatively low cost because it can be manufactured without controlling atmosphere in the whole manufacturing process.

### Embodiment 2

Another example of the PDP of the present invention (Embodiment 2) is shown in FIGS. 3 and 4. FIG. 3 is an exploded perspective view of the PDP 200. FIG. 4 is a longitudinal sectional view (a sectional view taken along a line I-I of FIG. 3) of the PDP 200.

The PDP 200 has a structure similar to the structure of the PDP 100 except that the protective layer 7 is made of MgO and the powder of the above-mentioned crystalline oxide material (hereinafter, referred to as a compound 20) is disposed on the protective layer 7 in particulate form. Similarly to the PDP 100, in the PDP 200, the powder of the compound 20 is disposed so as to face the discharge space 14.

The PDP 200 having the above-mentioned structure can offer favorable image display performance and be driven with low power, similarly to the PDP 100. Additionally, since the PDP 200 includes the protective layer 7 made of MgO, effects of the protective layer 7 (i.e. effects of protecting the dielectric layer 6 and lengthening life of the dielectric layer 6 due to high resistance to ion bombardment) can be exhibited in the PDP 200.

<Manufacturing Method of PDP>

The following describes an example of a manufacturing method of a PDP to which the powder of the crystalline oxide material of the present invention is dispersed. Note that the following manufacturing method of the PDP is just an example. Therefore, the method can be changed accordingly within the scope of the present invention.

First, a front plate is produced. A plurality of linear transparent electrodes 3 are formed on one major surface of the flat front glass substrate 2. After silver contained pastes are applied to the transparent electrodes 3, the entire front glass substrate 2 is heated to bake the silver contained pastes, and thus the display electrodes 4 are formed to obtain the display electrodes 5.

A glass paste that includes glass for the dielectric layer is applied to the major surface of the front glass substrate 2 by a blade coater method so as to cover the display electrodes 5. The entire front glass substrate 2 is then held at 90 degrees Celsius for 30 minutes to dry out the glass paste, and subsequently baked at about 580 degrees Celsius for 10 minutes. The dielectric layer 6 is formed in the above-mentioned manner.

Next, in order to produce a PDP having the structure shown in Embodiment 1, a thick film made of the above-mentioned crystalline oxide material is formed instead of the protective layer made of MgO. Specifically, the powder of the crystalline oxide material is mixed with a vehicle, a solvent, and the like to form a paste with relatively high powder content. The paste is then spread over the dielectric layer 6 by a method such as the printing method. The paste is baked to form a thick film.

In order to produce a PDP having the structure shown in Embodiment 2, after the protective layer 7 made of MgO is formed on the dielectric layer 6, the powder of the crystalline oxide material is dispersed on a surface of the dielectric layer 6. First, a magnesium oxide (MgO) film is formed on the dielectric layer by an electron beam deposition method to form the protective layer 7. The powder of the compound 20 is then disposed on a surface of the protective layer 7 made of MgO. When the powder of the compound 20 is disposed on the surface of the protective layer 7, a paste with relatively low powder content may be applied by the printing method and the like, solvent in which the powder is dissolved may be dispersed, or the powder may be disposed by a method such as a spin coat method and baked at about 500 degrees Celsius.

When the powder of the compound 20 is disposed by the printing method, the powder of the compound 20 of the present invention is mixed with a vehicle such as ethyl cellulose to form a paste. The paste is then applied to the protective layer 7 made of MgO by the printing method and the like. The applied paste is dried out, and baked at about 500 degrees Celsius. A dispersion layer made of the powder of the compound 20 is formed in the above-mentioned manner.

This concludes a method for producing the front plate.

A back plate is produced in a process different from the process of producing the front plate. After a plurality of linear silver contained pastes are applied to one major surface of the flat back glass substrate, the entire back glass substrate is heated to bake the silver contained pastes, and thus the address electrodes are formed.

After glass pastes are applied between adjacent address electrodes, the entire back glass substrate is heated to bake the glass pastes, and thus the barrier ribs are formed.

Phosphor inks of colors of R, G and B are applied between adjacent barrier ribs. The back glass substrate is then heated at about 500 degrees Celsius to bake the phosphor inks and to eliminate resin components (binders) and the like in the phosphor inks, and thus the phosphor layer is formed.

The front and back plates thus obtained are sealed together with use of sealing glass. The temperature at the time is about 500 degrees Celsius. Thereafter, the inside of the sealed plates is evacuated to a high vacuum and then filled with a discharge gas composed of a rare gas.

The PDP of the present invention can be obtained by performing the above-mentioned manufacturing processes.

<Performance Evaluation Experiment of Embodiments>

The following describes a performance evaluation experiment conducted on the compound of the present invention and PDPs produced by using the crystalline oxide material that contains the compound, in more detail.

### [Experiment 1]

### [Evaluation of Chemical Stability of Crystalline Compound]

An effect of improving chemical stability was evaluated for crystalline compounds synthesized by reacting a base powder of SrO or BaO with a powder of CeO₂ based on a solid phase reaction method.

Guaranteed reagent or purer CaCO₃, SrCO₃, BaCO₃, and CeO₂ were used as starting materials. After these materials were weighed so that a molar ratio of each metal ion showed a value in Table 1, the weighed materials were wet blended with use of a ball mill, and dried out to obtain mixed powders (Sample No. 2 to 6).

Each of the obtained mixed powders was placed into a platinum crucible, and baked in the air at 1100 to 1300 degrees Celsius for 2 hours in an electric furnace. After an average particle size of each of the baked mixed powders was measured, particles having particle sizes larger than the measured average particle size were wet milled using ethanol as a solvent. In this manner, the average particle size was set to be about 3 μm in all compositions. A formation phase was identified by analyzing a part of the milled powder using an X-ray diffraction.

Next, after a part of the milled powder was weighed, the weighed powder was filled into a non-hygroscopic porous cell. The cell was then placed in a constant temperature and moisture chamber with a temperature of 35 degrees Celsius and 60% humidity for 12 hours. After that, the part of the milled powder was weighed again to measure a weight increasing rate. The cell was, then, placed in a constant temperature and moisture chamber with a temperature of 65 degrees Celsius and 80% humidity for 12 hours. After that, the part of the milled powder was weighed again to measure a weight increasing rate (an integrated value). Here, it can be considered that the lower the weight increasing rate is, the more chemically stable a compound is. For some samples, measurement using the X-ray diffraction was performed after the treatment in the constant temperature and moisture chamber.

For comparison, weight increasing rates of an MgO powder as Sample No. 0 and a sample obtained by reacting, instead of CeO₂, SiO₂ being an oxide of a tetravalent metal with SrCO₃ as Sample No. 7 were measured in a similar manner.

TABLE 1

| | | | | | | | Weight increasing rate (Wt %) | | |
|---|---|---|---|---|---|---|---|---|---|
| | Composition ratio (mol %) | | | | | | 35° C. | +65° C. | Working Example or |
| No. | Ca | Sr | Ba | Ce | Others | Formation phase | 60% 12 h | 80% 12 h | Comparative Example |
| 0 | | | | | Mg = 100 | MgO | 0.0 | 0.8 | Comparative Example |
| 1 | 100 | | | | | CaO | 36.5 | — | Comparative Example |
| 2 | | 100 | | | | SrO + Sr(OH)₂ | 34.3 | — | Comparative Example |
| 3 | | | 100 | | | Ba(OH)₂ + BaCO₃ | — | — | Comparative Example |
| 4 | 50 | | | 50 | | CaO + CeO₃ | 11.5 | — | Comparative Example |
| 5 | | 50 | | 50 | | SrCeO₃ | 0.5 | 2.8 | Working Example |
| 6 | | | 50 | 50 | | BaCeO₃ | 0.2 | 2.0 | Working Example |
| 7 | | 50 | | | Si = 50 | SrSiO₃ | 1.0 | 4.7 | Comparative Example |

From the results shown in Table 1, in analyses using the X-ray diffraction of formation phases in Sample No. 1 to 3 which had been prevented from reacting with CeO₂, formation of CaO was observed in Sample No. 1. Presence of mixed Sr(OH)₂ in SrO, however, was observed in Sample No. 2, and BaO itself was not observed but a mixture of Ba(OH)₂ and BaCO₃ was observed in Sample No. 3. This is because SrO is less chemically stable than CaO, and furthermore BaO is less chemically stable than SrO. Therefore, it is considered that SrO and BaO reacted with moisture and carbon dioxide in the air during cooling after baking and consequently hydroxide and carbonate were produced. Since BaO was not observed in Sample No. 3 and thus it was obvious that Sample No. 3 was the least stable, measurement of the weight increasing rate of Sample No. 3 after the treatment in a constant temperature and moisture chamber was not performed.

In Sample No. 4, a mixture of CaO and CeO₂ was observed. This is because there are no compounds consisting of CaO and CeO₂.

On the other hand, formation of intended compounds, namely, SrCeO₃, BaCeO₃, and SrSiO₃ were observed in Sample No. 5, 6, and 7, respectively.

Next, in measurement of a weight increasing rate after the treatment in the constant temperature and moisture chamber with a temperature of 35 degrees Celsius and 60% humidity for 12 hours, weight increasing rates of CaO in Sample No. 1 and SrO in Sample No. 2 were very high. Furthermore, in X-ray diffraction of these samples after the treatment, a diffraction peak of an oxide disappeared, and formation of hydroxide and carbonate was observed. Therefore, since it was obvious that CaO in Sample No. 1 and SrO in Sample No. 2 were less chemically stable after BaO in Sample No. 3, an additional treatment under the condition of 65 degrees Celsius and 80% humidity for 12 hours was not performed.

In measurement of a weight increasing rate after the treatment in the constant temperature and moisture chamber with a temperature of 35 degrees Celsius and 60% humidity for 12 hours, a weight increasing rate of Sample No. 4 was very high. Furthermore, in X-ray diffraction of Sample No. 4 after the treatment, a diffraction peak of CaO disappeared, and a mixture of Ca(OH)₂, CaCO₃, and CeO₂ was observed. This is because there are no compounds consisting of CaO and CeO₂.

By contrast, weight increasing rates of Sample No. 5 and 6 were lower than those of Sample No. 1 to 4. Weight increasing rates of Sample No. 5 and 6 were also low under the condition of 65 degrees Celsius and 80% humidity for 12 hours. Furthermore, in the X-ray diffraction after the treatment, only diffraction peaks of SrCeO₃ and BaCeO₃ were observed in Sample No. 5 and 6, respectively, and stability that was equivalent to that of MgO in Sample No. 0 as comparative example was confirmed.

A little increase in weight was observed in Sample No. 7, the weight increasing rate of Sample No. 7 was lower than that of Sample No. 2. In the X-ray diffraction after the treatment, only a diffraction peak of SrSiO₃ was observed, and it was confirmed that Sample No. 7 was relatively stable.

### [Evaluation Using XPS]

When the powder of the crystalline oxide material that contains the compound is disposed so as to face a discharge space in a PDP, it is important to stabilize the disposed powder of the crystalline oxide material and to prevent a secondary electron emission coefficient of a protective layer from being reduced. In a PDP, however, it is not easy to directly measure a secondary electron emission coefficient of the powder of the crystalline oxide material. Although the secondary electron emission coefficient can be indirectly measured by observing a decrease in discharge voltage in a PDP, it is not easy to produce PDPs for all materials.

After a detailed examination, the inventors found that materials capable of lowering discharge voltage in a PDP can be selected to some extent by measuring and comparing an energy position of a valence band edge level in the band structure and an amount of carbon attributable to carbonate using an X-ray Photoelectron Spectroscopy (hereinafter, abbreviated as XPS). The XPS is used for measuring a spectrum of an electron that is emitted by X-irradiating a sample surface. In general, an analyzing depth thereof is considered to range from some atomic layers to more than a dozen atomic layers. Information about a sample surface that is closely linked to secondary electron emission in a PDP can be obtained using the XPS.

It is generally considered that the smaller a sum of a band gap width and electron affinity is, the higher a secondary electron emission coefficient is. The secondary electron emission coefficient becomes higher when an energy position of a valence band edge level is on a lower energy side because a band gap width becomes smaller at the time.

On the other hand, in a compound that includes alkaline earth metals, the amount of carbon attributable to carbonate in a surface region of the sample provides an indication of chemical stability more accurately than the measurement results of hygroscopicity shown in Table 1. When a sample is chemically unstable, the sample readily reacts with carbon dioxide in the air and thus an amount of carbon in a surface region of a sample is increased. When the amount of carbon in the surface region of the sample reaches or exceeds a certain amount, particle surfaces are completely covered with alkaline earth carbonate such as BaCO₃ having a low secondary electron emission coefficient. In this case, even when the energy position of a valence band edge level is on a low energy side, a high secondary electron emission coefficient cannot be obtained.

Therefore, by measuring and comparing an energy position of a valence band edge level and an amount of carbon attributable to carbonate using the XPS, the material capable of reducing discharge voltage in a PDP can be selected to some extent.

XPS measurement was performed for Sample No. 0 to 7 in order to select such materials.

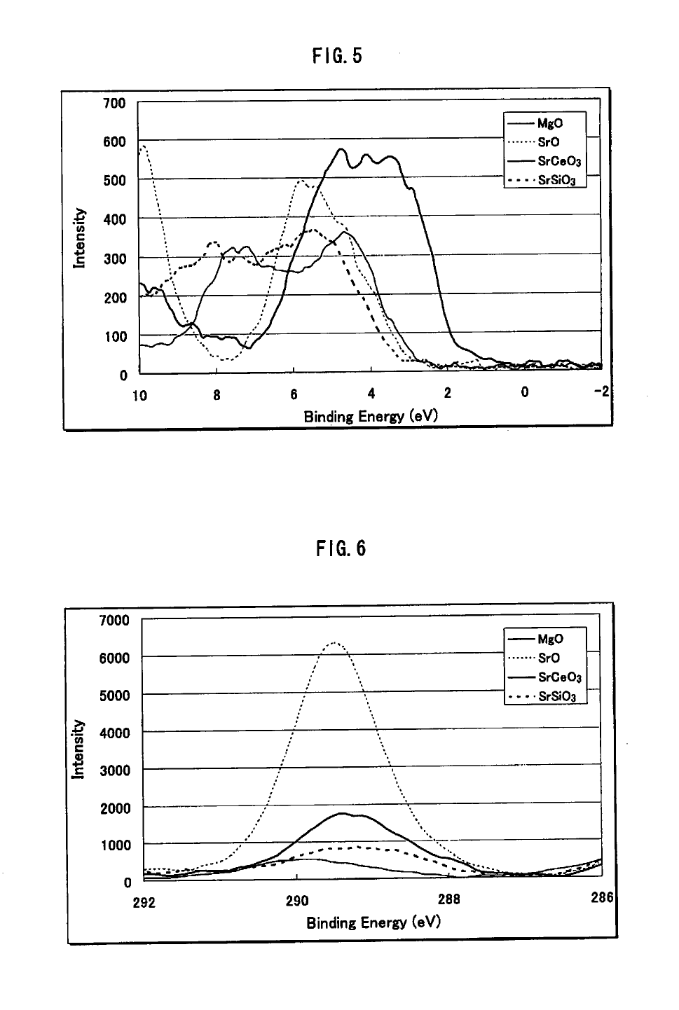

FIGS. 5 and 6, respectively, show valence band edge level XPS spectra and C1s XPS spectra of Sample No. 0, 2, 5, and 7, namely, MgO, SrO, SrCeO₃, and SrSiO₃ in Table 1. Note that background noises are eliminated in FIGS. 5 and 6. As can be seen from FIG. 5, a valence band edge level of SrO is at almost the same position as that of MgO. The valence band edge level position of SrSiO₃, however, is slightly shifted to a higher energy side and the valence band edge level position of SrCeO₃ is largely shifted to a lower energy side than the valence band edge level position of MgO.

On the other hand, in FIG. 6, while a peak of C attributable to carbonate appears in a range of about 288 to 290 eV, a peak of SrO is much higher than a peak of MgO. Although peaks of SrSiO₃ and SrCeO₃ are also higher than the peak of MgO, they are much lower than the peak of SrO.

Since SrO originally has higher secondary electron emission properties (γ) than MgO, a valence band edge level position of SrO is considered to be on a lower energy side than that of MgO in FIG. 5. In the experiment results, however, the valence band edge level position of SrO was on a higher energy side than that of MgO. Presumably, this is because a sample surface has already changed from SrO to SrCO₃ due to an extremely large amount of C in the surface region of the sample as shown in FIG. 6. On the other hand, although an amount of C is not so large in SrSiO₃, the valence band edge level position of SrSiO₃ is on a higher energy side than that of MgO. This indicates that stability of SrSiO₃ is improved by SrO reacting with SiO₂, but γ is reduced compared with SrO before the reaction.

By contrast, SrCeO₃ is stabilized because an amount of C in a surface region of a sample is much smaller than that in SrO. In addition, since the valence band edge level position of SrCeO₃ is on much lower side than that of MgO, SrCeO₃ is expected to have high secondary electron emission efficiency.

Next, XPS measurement results of the compounds (Sample No. 0 to 7) in Table 1 are shown in Table 2. In Table 2, in order to semi-quantitatively show a valence band edge level position and an amount of C, XPS intensity of peaks appearing at 3 eV and 2 eV (the valence band edge level position is shifted to a lower energy side and better secondary electron emission properties are shown, as the peak intensity becomes greater.), and intensity of C1s peaks appearing in a range of about 288 to 290 eV that are attributable to carbonate (the less the peak intensity is, the more chemically stable the particle surfaces are.) are shown. Note that values of background noises are not included in the values shown in Table 2.

TABLE 2

| | Composition ratio ( ) | | | | | | XPS Intensity (count) | | | Working Example or |
|---|---|---|---|---|---|---|---|---|---|---|
| No. | Ca | Sr | Ba | Ce | Others | Formation phase | 3 eV | 2 eV | C peak | Comparative example |
| 0 | — | — | — | — | Mg = 1.0 | MgO | 51.5 | 0.8 | 550 | Comparative Example |
| 1 | 1.0 | | | | | CaO | 25.1 | 2.5 | 2030 | Comparative Example |
| 2 | | 1.0 | | | | SrO + Sr(OH)₂ | 29.4 | 3.5 | 5980 | Comparative Example |
| 3 | | | 1.0 | | | Ba(OH)₂ + BaCO₃ | 50.6 | 4.9 | 5260 | Comparative Example |
| 4 | 1.0 | | | 1.0 | | CaO + CeO₂ | — | — | — | Comparative Example |
| 5 | | 1.0 | | 1.0 | | SrCeO₃ | 465 | 128.3 | 1760 | Working Example |
| 6 | | | 1.0 | 1.0 | | BaCeO₃ | 349 | 88.8 | 1870 | Working Example |
| 7 | | 1.0 | | | Si = 1.0 | SrSiO₃ | 17.9 | 0.6 | 860 | Comparative Example |

As can be seen from the measurement results shown in Table 2, it could be confirmed that the XPS intensity of peaks appearing at 3 eV and 2 eV of compounds of the present invention (Sample No. 5 and 6) was greater than that of an alkaline earth alone (Sample No. 1 to 3), and an amount of C in the compounds of the present invention was smaller than that of an alkaline earth alone. It could be found, however, that amounts of C in Sample No. 5 and 6 were both larger than that in MgO in Sample NO. 0.

### [Experiment 2]

Next, based on BaCeO₃, an effect of elemental substitution was evaluated in each compound.

By a method similar to the method used in Experiment 1, guaranteed reagent or purer SrCO₃, BaCO₃, CeO₂, and oxides of various metals were used as starting materials. After these materials were weighed so that each of element ratios showed a value in Table 3, the weighed materials were blended, dried out, and baked to obtain various powders of compounds (Sample No. 11 to 16). Identification using the X-ray diffraction, measurement of a specific surface area, and XPS measurement were performed for the obtained compounds.

TABLE 3

| | Composition ratio | | | XPS Intensity | | |
|---|---|---|---|---|---|---|
| | (Ba = 1.0) | | Formation phase | (count) | | Working Example or |
| No. | Ce | Others | (X-ray diffraction) | 2 eV | C peak | Comparative Example |
| 6 | 1.0 | — | BaCeO₃ | 88.8 | 1870 | Working Example |
| 11 | 0.8 | In = 0.2 | Ba(Ce_{0.8}In_{0.2})Oₓ | 240.0 | 1490 | Working Example |
| 12 | 0.5 | In = 0.5 | Ba(Ce_{0.5}In_{0.5})Oₓ | 167.7 | 1620 | Working Example |
| 13 | 0.0 | In = 1.0 | Ba₂In₂O₅ | 61.3 | 2200 | Comparative Example |
| 14 | 0.9 | Y = 0.05 | Ba(Ce_{0.95}Y_{0.05})Oₓ | 104.2 | 1560 | Working Example |
| 15 | 0.2 | Sn = 0.2 | Ba(Ce_{0.8}Sn_{0.2})O₃ | 118.7 | 1040 | Working Example |
| 16 | 0.5 | Sn = 0.5 | Ba(Ce_{0.5}Sn_{0.5})O₃ | 71.0 | 620 | Working Example |

As shown in Table 3, in Sample No. 11 to 13, Ce was substituted with In. Ce was partially substituted with Y in Sample No. 14, and Ce was partially substituted with Sn in Sample No. 15 and 16. In all samples including BaCeO₃ in Sample No. 6, diffraction patterns of perovskite structures were shown in the X-ray diffraction.

From results in Sample No. 11 to 14, it could be found that, when Ce was partially substituted with In or Y, XPS intensity of peaks appearing at 2 eV was increased and an amount of C in a surface region of a sample was decreased. When the substitution ratio was too high as in the case of Sample No. 12, however, the XPS intensity of peaks appearing at 2 eV began to be reduced and an amount of C began to be increased. In Sample No. 13 in which all sites for Ce were substituted with In, it could be confirmed that the XPS intensity of peaks appearing at 2 eV was reduced and an amount of C was increased compared with those in Sample No. 6 in which the substitution was not performed.

From results in Sample No. 15 and 16, it could be found that, an amount of C in a surface region of a sample was decreased when Ce was partially substituted with Sn, but the XPS intensity of peaks appearing at 2 eV was slightly reduced when the substitution ratio was increased.

As described above, by substituting Ce with a trivalent or tetravalent metal ion, an effect of improving an XPS intensity of peaks appearing at 2 eV and an amount of C could be obtained. A similar effect could be obtained when Ce in SrCeO₃ was substituted, although no example will be provided here. From the experiment results, a rare earth metal including In or Y is considered to be preferable as a trivalent metal substituting Ce.

### [Experiment 3]

Next, performance of PDPs produced by using a crystalline oxide material that contains the compound of the present invention that had been chemically stabilized was evaluated.

### [Manufacturing Method of PDP]

A flat front glass substrate that had a thickness of about 2.8 mm and was made of soda lime glass was prepared. ITO (a material for a transparent electrode) was applied to a surface of the front glass substrate in a predetermined pattern, and dried out. Next, a plurality of linear silver contained pastes that were mixtures of a silver powder and an organic vehicle were applied. The front glass substrate was then heated to bake the silver contained pastes, and consequently display electrodes were formed.

A glass paste was applied, by a blade coater method, to a front panel on which the display electrodes were formed. The glass paste was dried out by being held at 90 degrees Celsius for 30 minutes, and then baked at 585 degrees Celsius for 10 minutes to form a dielectric layer having a thickness of about 30 μm.

After magnesium oxide (MgO) was deposited on the dielectric layer by an electron beam deposition method, a protective layer was formed by baking the deposited magnesium oxide at 500 degrees Celsius.

Next, 2 parts by weight of each powder shown in Table 2 and 3 were mixed with 100 parts by weight of an ethyl cellulosic vehicle, and the mixture was milled by using a triple roll mill to form a paste. A thin layer of the paste was applied to the protective layer (an underlying film) by a printing method, and dried out at 120 degrees Celsius. The thin layer was baked in the air at 500 degrees Celsius. At this time, a ratio at which the protective layer was covered with a powder after the baking was adjusted to about 15% by controlling the concentration of the paste. For comparison, a PDP that included only the protective layer made of MgO on which the paste was not printed (Sample No. 0) was also produced.

On the other hand, a back plate was produced in the following manner. First, address electrodes that were mainly made of silver were formed in stripes on a back glass substrate made of soda lime glass by screen printing. A dielectric layer having a thickness of about 8 μm was then formed in a manner similar to the manner to form the dielectric layer on the front plate.

Next, barrier ribs were formed between adjacent address electrodes on the dielectric layer with use of glass pastes. The barrier ribs were formed by repeatedly performing screen printing and baking.

Red (R), green (G) and blue (B) phosphor pastes were then applied to walls of the barrier ribs and exposed surfaces of the dielectric layer between barrier ribs, dried out and baked to produce a phosphor layer.

The produced front plate and back plate were sealed together at 500 degrees Celsius with use of a sealing glass. After the air was evacuated from a discharge space, Xe was enclosed in the discharge space as a discharge gas, and consequently a PDP was produced (Sample No. 0, 5 to 7, and 11 to 16).

Each of the produced PDPs was connected to a drive circuit to perform aging processing. At 50 hours and 200 hours after the start of the aging processing, sustaining voltage was measured. Here, the aging processing was performed for cleaning surfaces of an MgO film and dispersed powders to some extent by sputtering. The aging processing is commonly performed in a manufacturing process of a PDP. When the aging processing is not performed, drive voltage of the PDP becomes high, whether powders are dispersed or not.

The following Table 4 shows results of drive voltage measurement after the aging processing.

TABLE 4

| | | | | | | Drive voltage | | Working Example or |
|---|---|---|---|---|---|---|---|---|
| No. | Sr | Ba | Ce | Others | Formation phase | 50 h | 200 h | Comparative Example |
| 0 | | | | Mg = 1.0 | MgO (Underlying film) | 247 V | 252 V | Comparative Example |
| 5 | 1.0 | | 1.0 | | SrCeO₃ | 257 V | 218 V | Working Example |
| 6 | | 1.0 | 1.0 | | BaCeO₃ | 261 V | 215 V | Working Example |
| 7 | 1.0 | | | Si = 1.0 | SrSiO₃ | 245 V | 250 V | Comparative Example |
| 11 | | 1.0 | 0.8 | In = 0.2 | Ba(Ce_{0.8}In_{0.2})Oₓ | 250 V | 211 V | Working Example |
| 12 | | 1.0 | 0.5 | In = 0.5 | Ba(Ce_{0.5}In_{0.5})Oₓ | 255 V | 209 V | Working Example |
| 14 | | 1.0 | 0.9 | Y = 0.05 | Ba(Ce_{0.95}Y_{0.05})Oₓ | 253 V | 213 V | Working Example |
| 15 | | 1.0 | 0.2 | Sn = 0.2 | Ba(Ce_{0.8}Sn_{0.2})O₃ | 241 V | 219 V | Working Example |
| 16 | | 1.0 | 0.5 | Sn = 0.5 | Ba(Ce_{0.5}Sn_{0.5})O₃ | 231 V | 221 V | Working Example |

Compared with Sample No. 0 as comparative example in which a powder was not disposed on a protective layer made of MgO, in panels as working examples (Sample No. 5 and 6) in which SrCeO₃ or BaCeO₃ was dispersed on the protective layer, an effect of the present invention could be confirmed. Although voltage of the panels as working examples was high in an initial stage of the aging processing, the voltage was reduced as the aging time progresses. There was little difference between Sample No. 7 as comparative example in which SrSiO₃ was dispersed on the protective layer and Sample No. 0 as comparative example in which a powder was not disposed on a protective layer made of MgO.

Next, in Sample No. 11 to 16 as working examples in which Ce in BaCeO₃ was substituted with In, Y, or Sn, increases in voltage after 50 hours of aging processing were kept relatively low, and therefore, it could be confirmed that a relatively short time was required for the aging processing. The aging processing for a long time can reduce productivity and can lead to an increase in cost. By substituting Ce in BaCeO₃ with In, Y, or Sn, an effect of the present invention of reducing time for the aging processing could also be confirmed.

### [Experiment 4]

Next, PDPs were produced such that a ratio at which the protective layer made of MgO was covered with an SrCeO₃ powder differs among PDPs, and properties of the produced PDPs were evaluated.

Specifically, by a method similar to the method used in Experiment 1, materials were blended so that a ratio of Sr to Ce is set to be 0.995:1, and the blended material was baked in the air at 1150 degrees Celsius for 2 hours to synthesize a powder with a particle size of about 1 μm. By a method similar to the method used in Experiment 1, six types of pastes to be printed each having a different paste concentration shown in Sample No. 21 to 26 in Table 5 were produced by using the synthesized powder. As shown in Sample No. 31 in Table 5, a paste including a SrCeO₃ powder of 1% and an MgO powder of 2% for improving the discharge delay was also produced. By using these pastes, seven types of PDPs in each of which a protective layer made of MgO was covered with a powder at a predetermined covering ratio were produced by a method similar to the method used in Experiment 1. In each of the produced PDPs, a covering ratio at which the MgO layer was covered with a powder was measured. Similarly to Experiment 3, aging processing was performed for each of the PDPs, and discharge voltage of each of the PDPs was measured at 50 hours and 200 hours after the start of the aging processing. The results of the measurement are shown in Table 5.

TABLE 5

| | Paste concentration | Covering ratio | Discharge voltage (V) | |
|---|---|---|---|---|
| No. | (Weight %) | (%) | After 50 h | After 200 h |
| 0 | 0.0% | 0 | 247 | 252 |
| 21 | 0.3% | 1.1 | 252 | 238 |
| 22 | 1.0% | 7.5 | 255 | 222 |
| 23 | 2.0% | 15.1 | 257 | 218 |
| 24 | 3.0% | 20.4 | 258 | 220 |
| 25 | 4.3% | 25.2 | 260 | 225 |
| 26 | 20% | 78.3 | 263 | 241 |
| 31 | 1.0% + MgO = 2% | 18.3 | 252 | 223 |

As can be seen from the results shown in Table 5, it could be confirmed that, after 200 hours of aging processing, discharge voltage in PDPs in each of which an SrCeO₃ powder was dispersed on the protective layer made of MgO by applying a paste (Sample No. 21 to 31) was reduced compared with a PDP in which the powder was not dispersed (Sample No. 0), irrespective of concentration of the paste.

It is natural that the higher the concentration of the paste is, the higher the ratio at which the protective layer is covered with a powder is. It could also be confirmed that discharge voltage after 50 hours of aging processing was increased and an aging time required to reduce discharge voltage was increased as the concentration of the paste increases.

As described above, discharge voltage after 50 hours of aging processing tends to be increased as the concentration of the paste and the covering ratio increase. In Sample No. 26 in which the covering ratio was almost 100%, although an effect of reducing voltage could be confirmed after 200 hours of aging processing, the effect was relatively small. Presumably, this is because of the following reason. The higher the covering ratio is, the larger the amount of powder is, and therefore, a longer time is required for cleaning particle surfaces. As a result, some residues were left on the particle surfaces.

On the other hand, in Sample No. 21 in which the covering ratio was 1.1%, voltage was reduced by short-term aging processing. A ratio by which the voltage was reduced, however, was a little. Presumably, this indicates that an effect of reducing voltage was suppressed because an amount of the powder was small.

In Sample No. 31 in which an MgO powder was dispersed together, an effect of reducing voltage similar to the effect obtained in Sample No. 22 in which the MgO powder was not dispersed could be observed. From the results, it could be confirmed that combined use of the MgO powder and the SrCeO₃ powder did not create negative effects but could produce a positive effect.

According to the above-mentioned experiment results and examination by the inventors, the effect of reducing voltage was excessively reduced when the covering ratio was less than 1.0%. On the other hand, when the covering ratio was more than 20%, a too long time was required for the aging processing.

Therefore, in the present invention, it is desirable that the covering ratio fall within a range of 1.0% to 20% inclusive.

### INDUSTRIAL APPLICABILITY

The present invention can provide a plasma display panel having improved discharge performance when applied to public facilities, home televisions and so on. Therefore, the present invention has a broad range of applicability.

### REFERENCE SIGNS LIST

1 front panel
2 front glass substrate
3 transparent conductive film
4 bus electrode
5 display electrode
6 dielectric layer
7 protective layer
8 back panel
9 back glass substrate
10 address electrode
11 dielectric layer
12 barrier rib
13 phosphor layer
14 discharge space
20 compound
100 and 200 plasma display panel (PDP)

1. A plasma display panel that has a plurality of electrodes and phosphors, causes discharge in a discharge space by applying voltage between one or more pairs of electrodes among the plurality of electrodes, and causes the phosphors to emit visible light by the discharge, wherein
a crystalline oxide material that contains a crystalline oxide selected from the group consisting of (i) at least one of SrCeO₃ and BaCeO₃ and (ii) a solid solution of SrCeO₃ and BaCeO₃ is disposed so as to face the discharge space.

2. The plasma display panel of claim 1, wherein
the crystalline oxide material further contains another crystalline oxide that is obtained by partially substituting one or more Ce atoms in the crystalline oxide of claim 1 with one or more trivalent or tetravalent metal atoms.

3. The plasma display panel of claim 2, wherein
the trivalent metal atoms are In atoms or rare earth metal atoms.

4. The plasma display panel of claim 2, wherein
the tetravalent metal atoms are Sn atoms.

5. A plasma display panel having first and second panels, the first panel including a first substrate, a plurality of first electrodes disposed on the first substrate, a first dielectric layer disposed so as to cover the first electrodes, and a protective layer disposed on the first dielectric layer, the second panel including a second substrate, a plurality of second electrodes disposed on the second substrate, a second dielectric layer disposed so as to cover the second electrodes, and a phosphor layer disposed on the second dielectric layer, wherein
the crystalline oxide material of claim 1 is used for the protective layer, and
the first and second panels oppose each other with a discharge space therebetween.

6. The plasma display panel of claim 5, wherein
a material composed of MgO is dispersed on the protective layer in particulate form.

7. A plasma display panel having first and second panels, the first panel including a first substrate, a plurality of first electrodes disposed on the first substrate, a first dielectric layer disposed so as to cover the first electrodes, and a protective layer disposed on the first dielectric layer, the second panel including a second substrate, a plurality of second electrodes disposed on the second substrate, a second dielectric layer disposed so as to cover the second electrodes, and a phosphor layer disposed on the second dielectric layer, wherein
the crystalline oxide material of claim 1 is dispersed on the protective layer in particulate form, and
the first and second panels oppose each other with a discharge space therebetween.

8. The plasma display panel of claim 7, wherein
a ratio at which the dispersed crystalline oxide material covers the protective layer is in a range of 1% to 20% inclusive.

9. The plasma display panel of claim 7, wherein
a material composed of MgO is dispersed on the protective layer in particulate form along with the crystalline oxide material.

10. The plasma display panel of claim 7, wherein
a material composed of MgO is dispersed on the crystalline oxide material in particulate form.
